(19) United States
(12) Patent Application Publication
(10) Pub. No.: US 2026/0077546 A1
(43) Pub. Date: Mar. 19, 2026

(54) BIAXIALLY ORIENTED MEMBRANES FROM DOUBLE LAYER, OIL FILLED SHEETS

(71) Applicant: Amtek Research International LLC, Lebanon, OR (US)

(72) Inventors: Richard W. Pekala, Corvallis, OR (US); Don Spitz, Lebanon, OR (US); Weston J. Wood, Lebanon, OR (US)

(21) Appl. No.: 19/109,658

(22) PCT Filed: Sep. 19, 2023
(86) PCT No.: PCT/US2023/074608

§ 371 Date: Mar. 7, 2025

Related U.S. Application Data
(60) Provisional application No. 63/376,211, filed on Sep. 19, 2022.

(51) Int. Cl. B29C 48/00; B29C 48/08; B29C 48/40; B29C 48/92; B29K 23/00; B29L 31/00

(52) U.S. Cl. CPC B29C 48/0018; B29C 48/0021; B29C 48/08; B29C 48/40; B29C 48/92; B29K 2023/0633; B29K 2023/065; B29K 2023/0675; B29K 2023/0683; B29L 2031/755

(57) ABSTRACT

The present disclosure relates to a process for the formation of freestanding, biaxially-oriented, microporous polyolefin films. In this approach, at least two separate oil-filled, cast or calendered films are stacked on top of each other and then subjected to biaxial orientation, followed by solvent extraction of the process oil (i.e., plasticizer), evaporation of the solvent, and heat stabilization prior to separation into individual microporous membranes that are wound into rolls.

### RELATED APPLICATIONS

This application claims priority to U.S. Provisional Patent Application No. 63/376,211, filed on Sep. 19, 2022, and titled BIAXIALLY ORIENTED MEMBRANES FROM DOUBLE LAYER, OIL FILLED SHEETS, which is incorporated herein by reference in its entirety.

### COPYRIGHT NOTICE

© 2023 Amtek Research International LLC. A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR § 1.71(d).

### TECHNICAL FIELD

The present invention relates to a new process for the formation of freestanding, biaxially-oriented, microporous polyolefin films. In this approach, two separate oil-filled, cast or calendered films are stacked on top of each other and then subjected to biaxial orientation, followed by solvent extraction of the process oil (i.e., plasticizer), evaporation of the solvent, and heat stabilization prior to separation into individual microporous membranes that are wound into rolls. This process is unique in that the layers do not bond together, thereby effectively doubling the output through the biaxial orientation and extraction steps. Such microporous membranes can be used to improve the manufacturability, performance, and safety of energy storage devices such as lithium-ion batteries.

### BACKGROUND OF THE INVENTION

Separators are an integral part of the performance, safety, and cost of lithium-ion batteries. During normal operation, the principal functions of the separator are to prevent electronic conduction (i.e., shorts or direct contact) between the anode and cathode while permitting ionic conduction via the electrolyte. Under abuse conditions, such as external short circuit or overcharge, the separator is required to shutdown at temperatures well below where thermal runaway can occur. Shutdown results from the collapse of pores in the separator due to melting and viscous flow of the polymer, thus slowing down or stopping ion flow between the electrodes. Nearly all Li-ion battery separators contain polyethylene as part of a single- or multi-layer construction so that shutdown begins at ˜130° C., near the melting point of polyethylene.

Separators for the lithium-ion market are presently manufactured via “dry” or “wet” processes. In the dry process, polypropylene (PP) or polyethylene (PE) is extruded into a thin sheet and subjected to rapid drawdown. The sheet is then annealed at 10-25° C. below the polymer melting point such that crystallite size and orientation are controlled. Next, the sheet is rapidly stretched in the machine direction (MD) to achieve slit-like pores or voids. Trilayer PP/PE/PP separators produced by the dry process are commonly used in lithium-ion rechargeable batteries.

Wet process separators composed of high molecular weight polyethylene are produced by extrusion of an oil/polymer mixture at elevated temperature, followed by phase separation, biaxial stretching, and extraction of the process oil (i.e., plasticizer). The resultant separators have elliptical or spherical pores with good mechanical properties in both the machine and transverse directions. PE-based separators manufactured this way have found wide use in Li-ion batteries.

More recently, battery failures in the field have demonstrated that shutdown is not a guarantee of safety. The principle reason is that, after shutting down, residual stress and reduced mechanical properties above the polymer melting point can lead to shrinkage, tearing, or pinhole formation. The exposed electrodes can then touch and create an internal short circuit that leads to more heating, thermal runaway and explosion. As such, many companies are focused on applying a ceramic-coating or high temperature polymer coating on the polyolefin separator to impart good, high temperature dimensional stability. The coating process is usually done in a secondary operation and is critical to the performance and safety of Li-ion cells used in electric vehicle applications.

As such, there is a need to further reduce the cost of the base polyolefin separator in addition to applying the least amount of ceramic or high temperature polymer, while still achieving the required performance.

### SUMMARY OF THE INVENTION

A benefit of the present invention is a reduced cost structure for the base polyolefin separator by stacking precursor, oil-filled cast films on top of each other as they are biaxially-oriented through expensive equipment prior to eventual extraction, drying, and heat stabilization to form the base polyolefin separator. The inventive process can effectively double the output of a separator production line, and has heretofore not been practiced using cast film technology. As used herein, the term “freestanding” refers to a web or membrane having sufficient mechanical properties for use in unwinding, coating, winding, slitting and other web handling operations. The terms “film,” “sheet,” “substrate,” “web,” and “membrane” can be used interchangeably, and the term membrane can be used to encompass webs, films, substrates, and sheets.

The present invention relates to a microporous, freestanding membrane that relies upon a special type of polyethylene, viz., ultrahigh molecular weight polyethylene (UHMWPE). UHMWPE usually exhibits a molecular weight (Mw) greater than about 3.1 to about 10 million grams/mol. The repeat unit of polyethylene is (—CH₂CH₂—)ₓ, where x represents the average number of repeat units in an individual polymer chain. In the case of polyethylene used in many film and molded part applications, x equals about 10,000 whereas for UHMWPE, x is approximately 150,000. This extreme difference in the number of repeat units is responsible for a higher degree of chain entanglement and the distinctive properties associated with UHMWPE.

One such property is the ability of UHMWPE to resist material flow under its own weight when heated above its melting point. This phenomenon is a result of its ultrahigh molecular weight and the associated long relaxation times even at elevated temperatures. Therefore, while UHMWPE is commonly available, it is difficult to process into fiber, sheet, or membrane form. The high melt viscosity requires both a compatible plasticizer and a twin screw extruder for disentanglement of the polymer chains such that the resultant gel can be processed into a useful form. This approach is commonly referred to as ‘gel processing’. In many cases, other polyolefins are blended with UHMWPE to lower the molecular weight distribution in order to impact properties after extraction of the plasticizer results in a porous film or sheet. Exemplary polymers that can be blended with UHMWPE include very high molecular weight polyethylene (VHMWPE) having a Mw greater than about 300,000 g/mol (e.g., from about 300,000 to about 3.1 million grams/mol), high density polyethylene (HDPE), and linear low density polyethylene (LLDPE).

In one embodiment of the invention, the microporous, freestanding polyolefin membrane is manufactured by combining a mixture of UHMWPE and one or more of VHMWPE, HDPE, or LLDPE with a processing oil or plasticizer (e.g., mineral oil). For instance, the microporous, freestanding polyolefin membrane can be manufactured by combining a mixture of UHMWPE, HDPE, and a processing oil or plasticizer (e.g., mineral oil). The mixture can be blended with the processing oil or plasticizer in sufficient quantity and extruded to form a homogeneous, cohesive mass. For example, the mixture can comprise 30-55% weight percent of the one or more polyolefins. The mass is processed using blown film, cast film, or calendering methods to give an oil-filled sheet of a reasonable thickness (<250 um). The oil-filled sheet can be further biaxially oriented to reduce its thickness and effect its mechanical properties. In an extraction operation, the oil is removed with a solvent that is subsequently evaporated to produce a microporous, freestanding membrane.

A schematic of a cast or calendered film process is shown in FIG. 1. In this process, the extrudate is passed through a sheet die and then cooled as it passes through a series of calender rolls to effect the recrystallization of the polymer phase. The oil-filled sheet is then passed through equipment to impart biaxial orientation. In some embodiments, the biaxial orientation can be done sequentially (as exemplified in FIG. 1), by first passing the oil-filled sheet through machine direction orientation (MDO) equipment followed by transverse direction orientation (TDO) equipment (or vice versa). In other embodiments, the biaxial orientation can alternatively be done by passing the sheet through customized equipment that accelerates (and/or stretches) the sheet in the machine direction as it simultaneously stretches it in the transverse direction. The biaxially oriented, oil-filled sheet is then passed through an extraction and drying process (which can includes various means of solvent recovery, such as carbon beds) to form a microporous membrane that is then heat-stabilized to relieve residual stress and eventually would into a roll. In practice, the oil-filled sheet is often 1 meter wide as it leaves the calender rolls and is converted to a much thinner, biaxially oriented microporous membrane that can be about 5 meters wide at the winder. In order to increase output, separator manufacturers that use a cast film process are focused on going both faster and wider, but an exponential increase in capital costs results as the required equipment gets even wider.

An advantage of the cast film process is better thickness control compared to other film processes. In addition, the cast film process allows for low molecular weight polyolefin polymers to be used in combination with the process oil.

The new process is shown in FIG. 2 and effectively combines two oil-filled cast sheets into a stacked arrangement prior to passing through biaxial stretching (e.g., simultaneous or sequential as discussed above) and the other downstream equipment. For instance, as shown in FIG. 2, two cast films layers are extruded and fed through equipment to impart biaxial orientation, which can be simultaneous (as depicted) or sequential (as shown in FIG. 1). The biaxially oriented, oil-filled sheets are then passed through an extraction and drying process (similar to FIG. 1) to form two microporous membranes that can be heat-stabilized and eventually would into separate rolls (depicted as the Separator 1 (Top Layer), and Separator 2 (Bottom Layer)). Advantageously, the two layers do not bond together prior to or during biaxial orientation, even if contact between the layers occurs.

The resultant microporous, freestanding polyolefin membranes generally comprise a porosity from about 35-65%. The pore size range is generally from about 10 nanometers to several microns, with an average pore size of less than about 1 micrometer. The thickness of the membranes (not including any coating) is generally about 3-25 μm, or about 20 μm or less. The resultant membranes can also be wound or stacked in a package to separate the electrodes in an energy storage device, for example, a battery, capacitor, supercapacitor, or fuel cell. Such membranes are beneficial to the manufacture of energy storage devices, particularly when coated with a ceramic layer to impart good high temperature dimensional stability while maintaining shutdown characteristics.

Additional objects and advantages of this invention will be apparent from the following detailed description of preferred embodiments thereof which proceeds with reference to the accompanying drawings.

### BRIEF DESCRIPTION OF THE DRAWINGS

FIG. 1 is a schematic diagram of a cast film separator manufacturing process.

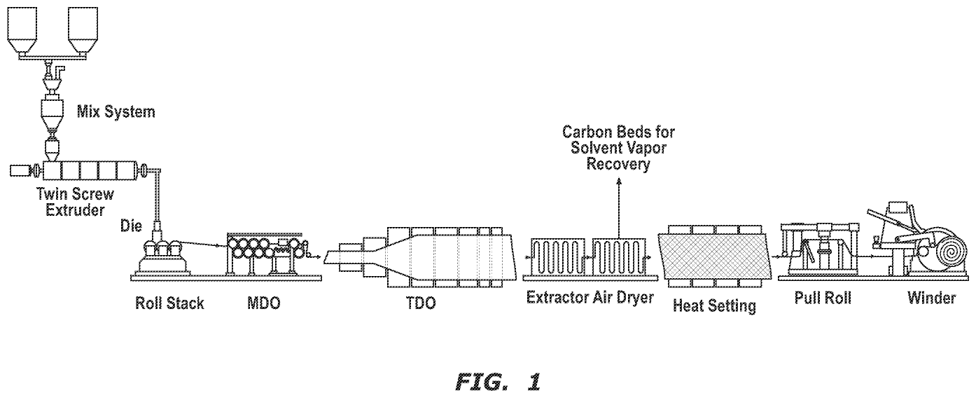

FIG. 2 is a schematic diagram of a new separator manufacturing process which depicts stacking two oil-filled sheets prior to biaxial orientation in accordance with an embodiment of the present disclosure.

### DETAILED DESCRIPTION

The membrane used in this invention is comprised of a polyolefin matrix or bulk structure. The polyolefin most preferably used is an ultrahigh molecular weight polyethylene (UHMWPE) having an intrinsic viscosity of at least 10 deciliter/gram, and preferably in the range from 18-22 deciliters/gram. In some instances, it is desirable to blend the UHMWPE with one or more other polyolefins such as VHMWPE, HDPE, or linear low-density polyethylene (LLDPE) in order to impact the shutdown properties of the membrane.

The processing oil or plasticizer employed in the present invention is a nonevaporative solvent for the polymer, and is preferably a liquid at room temperature. The processing oil or plasticizer has little or no solvating effect on the polymer at room temperature; it performs its solvating action at temperatures at or above the softening temperature of the polymer. For UHMWPE, the solvating temperature would be above about 160° C., and preferably in the range of between about 160° C. and about 220° C. It is preferred to use a processing oil, such as a paraffinic oil, naphthenic oil, aromatic oil, or a mixture of two or more such oils. Examples of suitable processing oils include: oils sold by Shell Oil Company, such as Gravex™ 942; and oils sold by Calumet Lubricants, such as Hydrocal™ 800; and oils sold by Nynas Inc., such as HR Tufflo© 750.

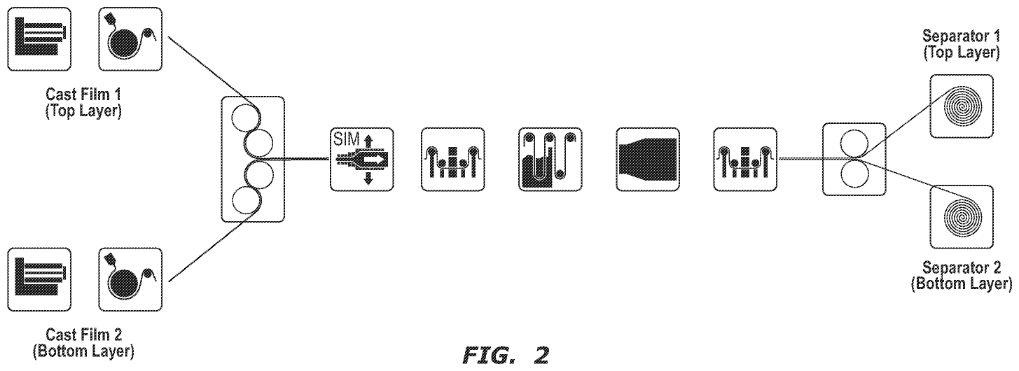

The polymer/processing oil mixture is extruded through multiple sheet dies, cast onto calender rolls, and then combined in a stacked arrangement which is subjected to biaxial orientation prior to the solvent extraction and drying steps (as exemplified in FIG. 2). The biaxial orientation can be carried out between 25° C. and the melting point of the polymer in the oil-filled sheet. For example, the biaxial orientation can occur at a temperature of from about 60° C. and about 100° C. In some instances, the oil-filled sheets are biaxially oriented from 4 to 12 times in the machine direction and from 4 to 12 times in the transverse direction. As discussed above, the biaxial orientation can be sequential or simultaneous. The stacked sheets also undergo biaxial orientation without sticking to each other. Any solvent that is compatible with the oil can then be used for the extraction step, provided it has a boiling point that makes it practical to separate the solvent from the plasticizer by distillation. Such solvents include 1,1,2 trichloroethylene, perchloroethylene, 1,2-dichloroethane, 1,1,1-trichloroethane, 1,1,2-trichloroethane, methylene chloride, chloroform, 1,1,2-trichloro-1,2,2-trifluoroethane, isopropyl alcohol, diethyl ether, acetone, decane, dodecane, hexane, heptane, toluene, mineral spirits, and their mixtures. In most cases, it is desirable to removal all the oil prior to the solvent drying step to prevent plasticization and potential bonding of the two sheets in the heat stabilization step.

### Example 1

The following polymers were mixed with process oil to form a ˜45 wt. % slurry that was fed into a twin screw extruder. The mixture was processed at ˜225° C. and extruded through a sheet die and calendered to form a 150-um thick, oil-filled sheet.

| | |
|---|---|
| 250 g | UHMWPE (GUR 4120; Celanese) |
| 125 g | VHMWPE (GUR 4012 (Celanese) |
| 125 g | HDPE (GHR 8020 (Celanese) |
| 600 g | Oil (Hydrocal 800; Calumet) |

The oil-filled sheet was wound onto plastic cores. In a separate operation, two layers of oil-filled sheet were stacked on top of each other and the biaxially oriented at 4× in the machine direction and 5× in the transverse direction. The two layer, biaxially oriented film was cut and sandwiched between metal frames that were clamped together and had a ˜100 mm×˜100 mm open area. This assembly was then washed with trichloroethylene to remove the process oil and subsequently dried in an oven at 85° C. to produce microporous membranes that could be separated from each other when removed from the metal frame.

It will be understood that reference throughout this specification to “an embodiment” or “the embodiment” means that a particular feature, structure or characteristic described in connection with that embodiment is included in at least one embodiment. Thus, the quoted phrases, or variations thereof, as recited throughout this specification are not necessarily all referring to the same embodiment.

Similarly, it should be appreciated that in the above description of embodiments, various features are sometimes grouped together in a single embodiment, figure, or description thereof for the purpose of streamlining the disclosure. This method of disclosure, however, is not to be interpreted as reflecting an intention that any claim require more features than those expressly recited in that claim. Rather, as the following claims reflect, inventive aspects lie in a combination of fewer than all features of any single foregoing disclosed embodiment. Thus, the claims following this Detailed Description are hereby expressly incorporated into this Detailed Description, with each claim standing on its own as a separate embodiment. This disclosure includes all permutations of the independent claims with their dependent claims. Moreover, additional embodiments capable of derivation from the independent and dependent claims that follow are also expressly incorporated into the present written description.

Recitation in the claims of the term “first” with respect to a feature or element does not necessarily imply the existence of a second or additional such feature or element.

References to approximations are made throughout this specification, such as by use of the term “about.” For each such reference, it is to be understood that, in some embodiments, the value, feature, or characteristic may be specified without approximation. For example, where the qualifier such as “about” is used, this term includes within its scope the qualified words in the absence of its qualifier. For example, where the term “about” is recited with respect to a feature, it is understood that in further embodiments, the feature can have a precise configuration. Unless otherwise stated, all ranges include both endpoints and all numbers between the endpoints.

Without further elaboration, it is believed that one skilled in the art can use the preceding description to utilize the invention to its fullest extent. The claims and embodiments disclosed herein are to be construed as merely illustrative and exemplary, and not a limitation of the scope of the present disclosure in any way. It will be apparent to those having ordinary skill in the art, with the aid of the present disclosure, that changes may be made to the details of the above-described embodiments without departing from the underlying principles of the disclosure herein. In other words, various modifications and improvements of the embodiments specifically disclosed in the description above are within the scope of the appended claims. Moreover, the order of the steps or actions of the methods disclosed herein may be changed by those skilled in the art without departing from the scope of the present disclosure. In other words, unless a specific order of steps or actions is required for proper operation of the embodiment, the order or use of specific steps or actions may be modified. The scope of the invention is therefore defined by the following claims and their equivalents.

1. A method of producing a freestanding, biaxially-oriented, microporous polyolefin membrane comprising the steps of:
(a) preparing a composition comprising one or more polyolefins and a process oil, wherein the lowest molecular weight polyolefin component is greater than 300,000 g/mol,
(b) passing the composition through a twin screw extruder and sheet die to form a cast oil-filled sheet,
(c) stacking at least two layers of the oil-filled sheet on top of each other so that they can undergo biaxial orientation together without sticking to each other,
(d) removing the process oil from the at least two oil-filled sheets with a solvent,
(e) drying the solvent to form at least two microporous polyolefin membranes, and
(f) heat stabilizing the at least two microporous polyolefin membranes to relieve residual stress prior to separating the two microporous polyolefin membranes and winding them into roll form.

2. The method of claim 1, wherein the composition comprises 30-55 weight percent of the one or more polyolefins.

3. The method of claim 1, wherein the composition comprises ultra-high molecular weight polyethylene (UHMWPE).

4. The method of claim 3, wherein the composition comprises a blend of ultra-high molecular weight polyethylene (UHMWPE) and at least one of very high molecular weight polyethylene (VHMWPE), high density polyethylene (HDPE), or linear low density polyethylene (LLDPE).

5. The method of claim 1, wherein each of the at least two layers of the oil-filled sheet is subjected to biaxial orientation from 4 to 12 times in the machine direction and from 4 to 12 times in the transverse direction.

6. The method of claim 1, wherein the at least two layers of the oil-filled sheet contact one another but do not bond together prior to or during biaxial orientation.

7. The method of claim 1, wherein the biaxial orientation occurs at a temperature of 60° C. and 100° C.

8. The method of claim 1, wherein the biaxial orientation occurs simultaneously in the machine and transverse directions.

9. The method of claim 1, wherein the biaxial orientation occurs sequentially in the machine direction and then the transverse direction.

10. The method of claim 1, wherein the at least two microporous polyolefin membranes each comprises a thickness of from 3 to 25 microns.

11. The method of claim 1, wherein the at least two microporous polyolefin membranes each comprises a porosity from about 35-65%.

12. The method of claim 1, wherein the at least two microporous polyolefin membranes each comprises micropores from about 10 nanometers to several microns, with an average pore size of less than about 1 micrometer.

13. A freestanding, biaxially-oriented, microporous polyolefin membrane formed according to the method of claim 1.

14. The freestanding, biaxially-oriented, microporous polyolefin membrane of claim 13, for use as a separator in a lithium ion or rechargeable Li metal battery.

15. The method of claim 1, wherein each of the at least two layers of the oil-filled sheet is subjected to biaxial orientation from 4 to 12 times in the machine direction.

16. The method of claim 1, wherein each of the at least two layers of the oil-filled sheet is subjected to biaxial orientation from 4 to 12 times in the transverse direction.

17. The method of claim 10, wherein the at least two microporous polyolefin membranes each comprises a thickness of 20 microns or less.

18. A method of producing a freestanding, biaxially-oriented, microporous polyolefin membrane comprising the steps of:
(a) preparing a composition comprising one or more polyolefins and a process oil, wherein the lowest molecular weight polyolefin component is greater than 300,000 g/mol,
(b) passing the composition through a twin screw extruder and sheet die to form a cast oil-filled sheet,
(c) stacking at least two layers of the oil-filled sheet on top of each other so that they can undergo biaxial orientation together without sticking to each other, wherein each of the at least two layers of the oil-filled sheet is subjected to biaxial orientation from 4 to 12 times in the machine direction and from 4 to 12 times in the transverse direction, and wherein the biaxial orientation occurs at a temperature of 60° C. and 100° C.,
(d) removing the process oil from the at least two oil-filled sheets with a solvent,
(e) drying the solvent to form at least two microporous polyolefin membranes, and
(f) heat stabilizing the at least two microporous polyolefin membranes to relieve residual stress prior to separating the two microporous polyolefin membranes and winding them into roll form.

19. The method of claim 18, wherein the biaxial orientation occurs simultaneously in the machine and transverse directions.

20. The method of claim 18, wherein the biaxial orientation occurs sequentially in the machine direction and then the transverse direction.
